(19) United States
(12) Patent Application Publication
(10) Pub. No.: US 2025/0287453 A1
(43) Pub. Date: Sep. 11, 2025

(54) BACKHAUL LINK MANAGEMENT, APPARATUS, AND COMPUTER-READABLE MEDIUM

(71) Applicant: ZTE Corporation, Shenzhen (CN)

(72) Inventors: Jianxun AI, Shenzhen (CN); Jing LIU, Shenzhen (CN); Ziyang LI, Shenzhen (CN); Nan ZHANG, Shenzhen (CN)

(73) Assignee: ZTE Corporation, Shenzhen (CN)

(21) Appl. No.: 19/213,125

(22) Filed: May 20, 2025

Related U.S. Application Data
(63) Continuation of application No. PCT/CN2023/076557, filed on Feb. 16, 2023.

(51) Int. Cl. H04W 76/20; H04W 24/10; H04W 36/08

(52) U.S. Cl. CPC H04W 76/20; H04W 24/10; H04W 36/08

(57) ABSTRACT

Wireless communication methods are disclosed. A wireless communication method includes receiving, by a wireless communication node, a forwarding configuration from a base station (BS), the forwarding configuration being associated with at least one first cell or at least one first frequency; and applying the forwarding configuration if a MT (mobile termination) part of the wireless communication node camps on the at least one first cell or at least one first frequency.

### TECHNICAL FIELD

This disclosure is generally related to wireless communication, and more particularly wireless communication regarding a backhaul link.

### BACKGROUND

Wireless communication technologies are pivotal components of the increasingly interconnecting global communication networks. Wireless communications rely on accurately allocated time and frequency resources for transmitting and receiving wireless signals. A repeater can increase the coverage of the wireless communication signal, but how to manage the backhaul link of the repeater can be improved.

### SUMMARY

This summary is a brief description of certain aspects of this disclosure. It is not intended to limit the scope of this disclosure.

According to some embodiments of this disclosure, a wireless communication method is provided. The method includes receiving, by a wireless communication node, a forwarding configuration from a base station (BS), the forwarding configuration being associated with at least one first cell or at least one first frequency; and applying the forwarding configuration if a MT (mobile termination) part of the wireless communication node camps on the at least one first cell or at least one first frequency.

According to some embodiments of this disclosure, another wireless communication method is provided. The method includes establishing a backhaul link between a base station (BS) and a wireless communication node; and sending, by the BS to the wireless communication node, a forwarding configuration to be applied by the wireless communication node when a MT (mobile termination) part of the wireless communication node camps on at least one first cell or at least one first frequency associated with the forwarding configuration.

According to some embodiments of this disclosure, another wireless communication method is provided. The method includes establishing a backhaul link between a base station (BS) and a wireless communication node; and controlling a forwarding operation of a forwarding part of the wireless communication node according to at least one of following factors, including a reference signal measurement result, a radio link quality of the backhaul link, a timer which starts in response to a MT (mobile termination) part of the wireless communication node enters an RRC idle state or an RRC inactive state, or a selection or reelection of a serving cell of the MT part.

According to some embodiments of this disclosure, another wireless communication method is provided. The method includes establishing a backhaul link between a base station and a wireless communication node; and receiving forwarded packets or radio signals from a forwarding part of the wireless communicant node via a forwarding operation controlled according to at least one of following factors, including a reference signal measurement result, a radio link quality of the backhaul link, a timer which starts in response to a MT (mobile termination) part of the wireless communication node enter an RRC idle state or an RRC inactive state, a selection or reelection of a serving cell of the MT part.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when performed by a processor, cause to perform any method or step or their combination in this disclosure.

According to some embodiments of this disclosure, one or more wireless communication methods are further disclosed, the methods include combinations of certain methods, aspects, elements, and steps (either in a generic view or specific view) disclosed in the various embodiments of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system with a repeater; and

FIG. 2 shows a component structure of different wireless communication nodes of FIG. 1.

### DETAILED DESCRIPTION

Communication coverage is one of focus aspects of cellular network deployments. Mobile operators rely on different types of network nodes to offer blanket coverage in their deployments. As a result, new types of network nodes have been considered in order to increase mobile operators' flexibility for their network deployments. For example, Integrated Access and Backhaul (IAB) was introduced and further enhanced to serve as a new type of network nodes, which does not require a wired backhaul. Another type of network node is the RF (Radio Frequency) repeater, which simply amplifies and forwards received signals. The RF repeaters have seen a wide range of deployments to supplement the coverage provided by regular full-stack cells.

A network-controlled repeater was also introduced as an enhancement over conventional RF repeaters with a capability to receive and process lateral control information from the network. Lateral control information may allow a network-controlled repeater to perform an amplify-and-forward operation in a more efficient manner. Potential benefits could include mitigation of unnecessary noise amplification, transmissions and receptions with better spatial directivity, and simplified network integration. Therefore, network-controlled repeaters are viewed by some industry players as a stepping stone of a re-configurable intelligent surface (RIS). An RIS node can adjust the phase and amplitude of received signal to improve the coverage.

This disclosure generally relates to, among other things, such kind of network nodes (or smart nodes (SN)), including, but not limited to, network-controlled repeater (NCR), smart repeater, RIS, IAB.

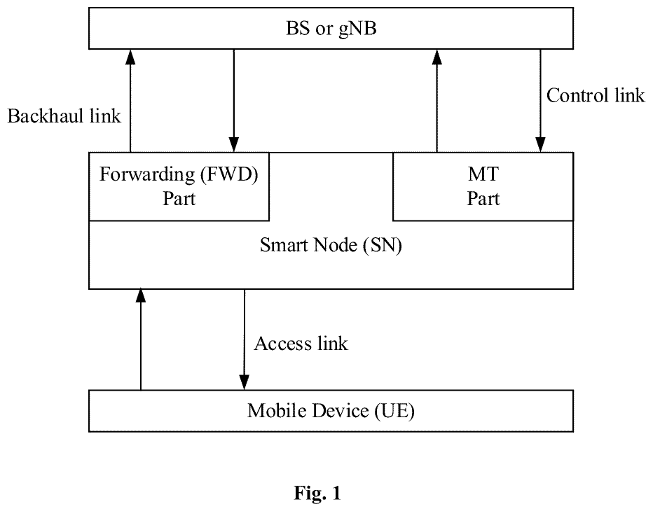

FIG. 1 illustrates an exemplary model of a wireless communication systems with an intermediate SN. The SN may include into two parts, the mobile termination (MT) part and the forwarding part. The radio link between the base station (BS) and the forwarding part include a backhaul link, and the radio link between the BS and the MT part include a control link. The radio link between the SN and the mobile device, or UE, include an access link. In the downlink transmission of the backhaul link, the forwarding part forwards the radio signals received from the BS and forwards to mobile device. In the uplink transmission of the backhaul link, the forwarding part forwards the radio signals received from the mobile device and forwards to the BS. The forwarding part may process the radio signals or only amplify the radio signals. The MT part may be connected to the BS as a normal mobile device. In addition, the MT part may receive side control information (forwarding configuration) from the BS. The control link may comprise one or more serving cell when the SN MT (i.e. the MT part) is in an RRC_CONNECTED state.

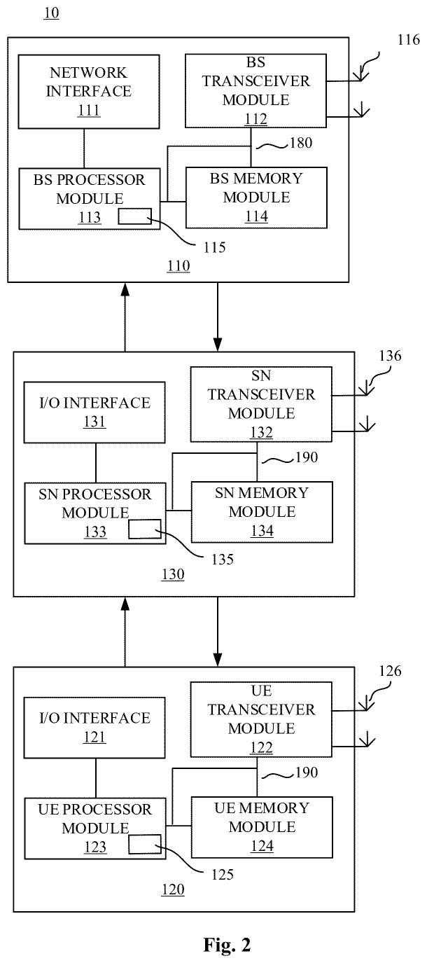

FIG. 2 illustrates a block diagram of an exemplary wireless communication system 10, in accordance with some embodiments of this disclosure. The system 10 may perform the various methods/steps disclosed in this disclosure. The system 10 may include components and elements configured to support operating features that need not be described in detail herein.

The system 10 may include a base station (BS) 110 and a user equipment (UE) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE 120 includes a UE transceiver or transceiver module 122, a UE antenna system 126, a UE memory or memory module 124, a UE processor or processor module 123, and an I/O interface 121. The components of the UE 120 may be electrically coupled and in communication with one another as necessary via a date communication bus 190. The SN 130, connected between the BS and the UE, includes a SN transceiver or transceiver module 132, a SN antenna system 136, an SN memory or memory module 134, an SN processor or processor module 133, and a network interface 131. The components of SN 130 may be electrically coupled and in communication with one another as necessary via a data communication bus 190. The BS 110 communicates with the UE 120 via the SN 130 and communication channel therebetween, which can be any wireless channel or other medium known in the art suitable for transmission of data as described herein.

As would be understood by persons of ordinary skill in the art, the system 10 may further include any number of modules other than the modules shown in FIG. 2. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

The processor modules 113, 123, 133 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, 133, respectively, or in any practical combination thereof. The memory modules 113, 123, 133 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124, 134 may be coupled to the processor modules 113, 123, 133, respectively, such that the processors modules 113, 123, 133 can read information from, and write information to, memory modules 114, 124, 134, respectively. The memory modules 114, 124, 134 may also be integrated into their respective processor modules 113, 123, 133. In some embodiments, the memory modules 114, 124, 134 may each include a cache memory for storing temporary variables or other intermediate information during execution of instructions to be performed by processor modules 113, 123, 133, respectively. The memory modules 114, 124, 134 may also each include non-volatile memory for storing instructions to be performed by the processor modules 113, 123, 133, respectively.

When an SN MT (i.e., the MT part of the SN as shown in FIG. 1) is in an RRC_CONNECTED state, the network can configure packet or radio signal forwarding configuration (e.g., side control information), such that the SN can forward the packets or radio signals from the UE to the BS according to the configuration. Due to the connection or other issues, the SN MT may transit to an RRC_IDLE state or an RRC_INACTIVE state. In this situation, the SN FWD part (i.e., the forwarding part as shown in FIG. 1) can be of a ON or OFF status following the last forwarding configuration received from the network. For example, the SN FWD part may perform forwarding according to the side control information (i.e. forwarding configuration) received by the SN MT before it is released to RRC_IDLE or RRC_INACTIVE state.

However, when the SN MT is in an RRC_IDLE state or an RRC_INACITVE state, the network cannot know the radio environment of the SN. The forwarding configuration may longer be proper for forwarding after the SN MT is transited to the RRC_IDLE or RRC_INACTIVE state as the BS cannot update the forwarding configuration of the SN. The consequence may include that the SN forwards and amplifies an unintended radio signal. The quality of the radio signal of the backhaul link may be improperly mismatch the intended quality. Also, this situation may result in unintended signal interference.

According to some embodiments of this disclose, methods that can be used to determine the state of the SN FWD part are provided when the SN MT is under an RRC_IDLE or RRC_INACTIVE state. The state of the SN FWD part can be determined, such that the SN FWD can take proper action(s), such as stopping forwarding the packets or radio signals to the BS or disregarding the outdated forwarding configuration.

According to some embodiments of this disclosure, the SN may determine the state of the SN FWD part according to at least one of the following conditions: (1) a measurement result is above a first threshold; or (2) a measurement result is above a threshold for a time duration. The measurement result, for example, can be some measurement result of one or more reference signals. As an example, the measurement result may include the RSRP (Reference Signal Received Power) or RSRQ (Reference Signal Received Quality) measurement results.

As an example, the measurement result may be the result of measurement based on one or more certain cells or one or more certain beams. The measured cell(s) may be the last serving cell of the SN MT before the SN MT transited to the RRC_IDLE or RRC_INACTIVE state, the current serving cell of the SN MT, or one cell among a cell set. The cell set may be configured by the BS via an RRC message or system information to the SN MT. Alternatively or additionally, the cell set may include the cell(s) to which the forwarding configuration is applicable. The cell set may include the cells for which the forwarding configuration is valid. On the other hand, the measured beam(s) may include the beam configured for downlink transmission of the backhaul link between the SN and the BS. Alternatively or additionally, the measured beam(s) may be beam(s) among a beam set, which can be configured by the BS via an RRC message or system information.

The threshold of the measurement result may be configured by the BS via an RRC message or system information. The time duration of the measurement may also be configured by the BS via an RRC message or system information. The configuration of the measurement parameters, like the threshold and the time duration, and other things related to the measurement can be configured by a same RRC message or system information, or by different RRC messages or pieces of system information. The RRC message may be the RRC message that transits SN MT to the RRC_IDLE or RRC_INACTIVE state.

The measurement may be performed by the SN MT or SN FWD part according to a measurement configuration. The measurement configuration may be configured via an RRC message or system information. The measurement configuration may include at least one of the following: a set of reference signal to perform measurement (corresponding to the parameter ssb-ToMeasure), an (absolute) threshold for the consolidation of measurement results per SSB resource (corresponding to the parameter absThreshSS-BlocksConsolidation), a maximum number of measurement results per beam based on SSB to be averaged (corresponding to the parameter nrofSS-BlocksToAverage), a measurement timing configuration (corresponding to the parameter SMTC), or a measurement cycle.

According to some examples, the measurement may be performed on a cell or a beam based on a measurement cycle. The measurement may be performed on the reference signal associated with the beam configured for downlink transmission of the backhaul link or the beam from a beam set. The measurement may be performed on a set of reference signals associated with the last serving cell before the SN MT transited to the RRC_IDLE or RRC_INACTIVE state, the current serving cell of the SN MT, or one cell from a cell set.

If the measurement result is within a predefined range or otherwise meets a predefined condition, the SN may keep forwarding packets or radio signals from the UE to the BS. The forwarding may be performed based on a forwarding configuration configured by the BS before the SN MT entered the RRC_IDLE or RRC_INACTIVE state.

If the measurement result is out of a predefined range or otherwise unsatisfactory to the condition, the SN may perform at least one of following actions, including: stop forwarding the received packets or radio signals from the UE by the SN FWD part; stopping applying the forwarding configuration by the SN FWD or SN MT part; or removing the forwarding configuration by the SN MT. According to some examples, the SN MT may initiate an RRC procedure to setup or resume the RRC connection between the SN and the BS. The RRC procedure may be an RRC connection setup procedure or an RRC connection resume procedure.

The BS may configure the SN to determine whether above actions should be performed or not and which one(s) should be performed by the SN MT via an RRC message or system information. The BS may indicate to the SN MT that the SN FWD part stops forwarding. The BS may further indicate to the SN MT to initiate an RRC setup or resume procedure when the above disclosed condition(s) are met.

Here, the BS can control the prerequisite for the SN forwarding part to keep forwarding the packets or radio signals. Even when the SN MT is in the RRC_IDLE state or RRC_INACTIVE state, when the BS cannot be aware of the radio environment, the BS can assure the SN forwarding is performed under a proper cell or beam quality.

According to some embodiments of this disclosure, the state of the SN can be determining by the radio link quality of the backhaul beam. For example, the SN may assess the quality of a reference signal (RS) when the SN MT is in the RRC_IDLE or RRC_INACTIVE state. The RS, of which quality is considered, may be at least one of: the RS associated to the DL (downlink) beam for the backhaul link or the RS associated with the beam configured by the BS via an RRC message.

In addition, the BS may configure one or more RSs for accessing of the radio link quality. The RS may be configured by indicating a reference signal index of a resource set. The resource set may be configured with frequency and time resource(s). For example, the resource set may include an SSB configuration or a CSI-RS configuration. The resource set may be located within or out of the frequency bandwidth of the initial DL BWP of the SN MT's serving cell.

According to some embodiments of this disclosure, the SN may determine the state of the SN FWD part according to an occurrence of a beam failure of certain RS(s).

The beam failure of the RS may be determined according to at least one of a threshold, a max count of the failure, and/or a timer value. The threshold, max count, and the timer value may be configured by the BS via an RRC message or system information.

For example, if a beam failure instance indication for the RS is received from lower layer of the SN, a count of beam failure instance is increased by 1. In response, the SN starts or restarts a timer. When the timer expires when it times to a preset value, the count of beam failure instance is reset to zero. When the count of beam failure instances reaches a max count (or a preset threshold), a beam failure for the RS can be declared.

The beam failure instance indication may be indicated from a lower layer of SN. For example, the lower layer of SN may assess the quality of the RS according to a threshold. The said assessment may be performed periodically.

The lower layer of the SN may indicate the beam failure instance indication for the RS if the quality of the RS is worse than the threshold, or if the RS is not the best RS in radio link quality among a resource set. The lower layer of SN may be the physical layer of the SN MT or the physical layer of the SN FWD part.

According to some embodiments of this disclosure, the SN may determine the state of the SN FWD part according to a determination that the RS is not the RS of best radio link quality among the resource set for a time duration. The resource set may be configured with frequency locations and time resource(s). For example, the resource set may include an SSB configuration or a CSI-RS configuration. The resource set may be located within or out of the frequency bandwidth of the initial DL BWP of the SN MT's serving cell. The length of the time duration may be configured by the BS via an RRC message or system information.

The radio link quality of the backhaul link may be assessed by a physical layer of SN MT or a physical layer of SN FWD part. The radio link quality may be assessed by the L1 (Layer 1) measurement on the RS. The L1 measurement result may be L1 RSRP or L1 RSRQ.

According to some embodiments of this disclosure, when the SN determines at least one of the following conditions is met, the SN may perform at least one of the following actions, including: stop forwarding the received packets and radio signals from the UE by the SN FWD part; stopping applying the forwarding configuration by the SN FWD or SN MT parts; removing the forwarding configuration by the SN MT; initiating an RRC procedure to setup or resume the RRC connection between the SN and the BS. The RRC procedure may be an RRC connection setup procedure or an RRC connection resume procedure. The conditions including that the radio link quality of the backhaul beam is out of a specific range, that a beam failure has been declared, or that the RS is not the RS of best radio link quality among the resource set for a time duration.

The BS may configure the SN to determine whether above actions should be performed or not and which one(s) should be performed by the SN MT via an RRC message or system information. The BS may indicate to the SN MT that the SN FWD part stops forwarding. The BS may further indicate to the SN MT to initiate an RRC setup or resume procedure when the above disclosed condition(s) are met. When the RRC procedure is started, the BS would respond to the SN to establish the RRC connection.

Here, the SN in the RRC_IDLE state or RRC_INACTIVE state may stop forwarding if the beam for the backhaul link is not within an expected quality. The physical layer of the SN may keep assessing the beam for the backhaul link. In case a beam failure occurs or the beam for the backhaul link is not the best beam among its resource set, the SN may stop forwarding. Further, the BS can configure the condition(s) for beam failure assessment.

According to some embodiments of this disclosure, the SN can use a timer to determine the state of the SN FWD part, so as to perform corresponding action(s) based on the timer.

For example, in response to the transition to the RRC_IDLE state or RRC_INACTIVE state, the SN may start a timer according to a timer value. The timer value may be configured by the BS via an RRC message or system information. The RRC message may be the RRC message that release the SN MT to the RRC_IDLE state or RRC_INACTIVE state.

When the timer is running after the state transition, the SN FWD part may keep performing the forwarding. The forwarding may be performed according to a forwarding configuration configured by the network or the BS before the SN entered the RRC_IDLE state or RRC_INACTIVE state.

The timer would keep counting when the SN MT stays at the RRC_IDLE state or RRC_INACTIVE state. When the timer reaches a predefined value or otherwise meets a condition, the SN FWD part may perform at least one of the following actions, including: stop forwarding the received packets or radio signals from the UE by the SN FWD part (meaning that the SN FWD is transit to an OFF state); stopping applying the forwarding configuration by the SN FWD or SN MT parts; removing the forwarding configuration by the SN MT; initiating an RRC procedure to setup or resume the RRC connection between the SN and the BS. The RRC procedure may be an RRC connection setup procedure or an RRC connection resume procedure.

The BS may configure the SN to determine whether above actions should be performed or not and which one(s) should be performed by the SN MT via an RRC message or system information. The BS may indicate to the SN MT that the SN FWD part stops forwarding. The BS may further indicate to the SN MT to initiate an RRC setup or resume procedure when the above disclosed condition(s) are met. When the RRC procedure is started, the BS would respond to the SN to establish the RRC connection.

Here, the BS can control the allowed time length when the SN forwarding is allowed to perform after the SN enters the RRC_IDLE state or RRC_INACTIVE state. This approach provides flexibility in configuring the behavior of the SN forwarding.

According to some embodiments of this disclosure, the SN FWD part can determine its state based on the cell selection or reselection of the SN MT when the SN MT is in the RRC_IDLE state or RRC_INACTIVE state.

For example, the SN may determine the state of the SN FWD part according to condition (1) that the SN MT selects or re-selects a serving cell that is not the last serving cell before the SN MT was transited to the RRC_IDLE state or RRC_INACTIVE state.

Additionally or alternatively, the SN may determine the state of the SN FWD part according to condition (2) that the SN MT selects or re-selects a serving cell that does not locate in a predefined frequency. As an example, the frequency may be the same frequency as the last serving cell (i.e., an inter-frequency neighbor cell) before SN MT was transited to the RRC_IDLE state or RRC_INACTIVE state. Additionally or alternatively, the frequency may be a frequency configured by the BS. The frequency may be associated with a forwarding configuration configured by the BS. The frequency may be the redirected carrier frequency as indicated by the BS when the SN MT is released to the RRC_IDLE state or RRC_INACTIVE state.

Additionally or alternatively, the SN may determine the state of the SN FWD part according to condition (3) that the SN MT selects or re-selects a serving cell which is not a suitable cell. As an example, a suitable cell satisfy at least one of the following conditions: the cell is part of either the selected PLMN or the registered PLMN or PLMN of the Equivalent PLMN list; the cell selection criteria are fulfilled; or the cell is not barred or forbidden for the SN MT. The suitable cell can also be defined according to the common understanding of the art.

Additionally or alternatively, the SN may determine the state of the SN FWD part according to condition (4) that the SN MT selects or re-selects a serving cell which is not the highest ranked cell or best cell according to an absolute priority reselection rules as specified in NR specification. Generally and exemplary, the cell performs cell ranking according to cell-ranking criterion Rs (for serving cell) and Rn (for neighboring cells), for all cells of intra-frequency or equal frequency and fulfil the cell selection criterion S. Highest ranked cell may be the cell that ranked the top according to cell ranking rule provided above. A best cell may be, for example, the highest ranked cell on the highest priority frequency among the cell that fulfill cell re-selection criteria.

Additionally or alternatively, the SN may determine the state of the SN FWD part according to condition (5) that the SN MT selects or re-selects a cell which is not the best cell or a cell of a highest priority.

Additionally or alternatively, the SN may determine the state of the SN FWD part according to condition (6) that the SN MT selects or re-selects a serving cell which is not one of configured cells. For example, the configured cells may be configured by the core network to the SN MT via an RRC message or system information. The configured cells may be the cells for which SN forwarding is allowed. The configured cells may be the cells in which a forwarding configuration configured by BS is valid or applicable. The configured cells may be associated with a forwarding configuration. The configured cell may be the redirected cell configured by the BS when the SN MT is released to the RRC_IDLE state or RRC_INACTIVE state.

Additionally or alternatively, the SN may determine the state of the SN FWD part according to condition (7) that the SN MT selects or re-selects a serving cell which is one of configured cells. The configured cells may be configured by a core network to the SN MT via an RRC message or system information. The configure cells may be the cells for which the SN forwarding is not allowed. The configured cells may be the cells in which the forwarding configuration configured by BS is invalid and or not applicable. The configured cells may be not associated with a forwarding configuration.

As an example, the cell selection above may be performed by the SN MT when it is transited to the RRC_IDLE or RRC_INACTIVE state. The cell re-selection may be performed by the SN MT when it is in the RRC_IDLE or RRC_INACTIVE state.

According to some embodiments of this disclosure, when the SN determines at least one of the conditions (1)-(7) is met (or alternatively not met), the SN may perform at least one of the following actions, including: stop forwarding the received packet from the UE by the SN FWD part; stopping applying the forwarding configuration by the SN FWD or SN MT parts; removing the forwarding configuration by the SN MT; initiating an RRC procedure to setup or resume the RRC connection between the SN and the BS. The RRC procedure may be an RRC connection setup procedure or an RRC connection resume procedure.

The BS may configure the SN to determine whether above actions should be performed or not and which one(s) should be performed by the SN MT via an RRC message or system information. The BS may indicate to the SN MT that the SN FWD part stops forwarding. The BS may further indicate to the SN MT to initiate an RRC setup or resume procedure when the above disclosed condition(s) are met. When the RRC procedure is started, the BS would respond to the SN to establish the RRC connection.

Here, the SN forwarding behavior can be determined based on the SN MT performing cell re-selection or selection and camping on a new serving cell. It should be noted that the disclosed different manners used to determine the state of the SN FWD part can be used together to form various combinations of different approaches selected from the disclosed steps in this disclosure.

According to the various disclosure above, the BS can control in which cell(s) the configured forwarding configuration is still valid or applicable. The BS can further configure a list of cells in which the SN forwarding configuration is applicable or valid. Thus, when the SN MT re-selects or selects one of these valid and applicable cells, the SN forwarding can continue according to configured forwarding configuration. The BS can, additionally or alternatively, configure a list of cells in which the SN forwarding configuration not applicable or invalid. When the SN MT re-selects or selects one of these invalid or inapplicable cells, the SN forwarding may be stopped. Thereby, the BS can further control the SN FWD part and SN MT's behavior upon the cell re-selection or selection.

According to some embodiment of this disclosure, the BS may further indicate whether cell re-selection is allowed for an SN MT in the RRC_IDLE or RRC_INACTIVE state. Additionally or alternatively, the BS may indicate whether inter-frequency cell re-selection is allowed for the SN MT in RRC_IDLE or RRC_INACTIVE state. The BS may indicate such configuration via an RRC message or system information to SN MT. Thereby, the SN MT may perform cell re-selection according to the indication. The BS, therefore, can control whether cell re-selection is allowed for an SN MT. It is beneficial in some deployment where the network operator does not allow the SN to perform cell re-selection to another cell due to the short term variation in serving cell's radio quality.

According to some embodiments of this disclosure, the BS may configure cell selection or re-selection configuration for an SN MT. The configuration may be SN-specific. The cell re-selection configuration may be a per-SN MT configuration and be configured to a SN MT via an RRC message. The cell selection or re-selection configuration may be a separate and/or different configuration from that for non-SN communication node, like a regular UE. The cell selection or re-selection configuration may be configured via an RRC message or system information. The SN MT may perform cell re-selection according to the cell re-selection configuration.

As an example, the cell selection or re-selection configuration may include at least one of following settings: (1) cell reselection priority for a frequency or a cell, (2) the minimum threshold for beams which can be used for selection of the highest ranked cells, or for beams used for derivation of cell measurement quantity, for current serving frequency or inter-frequency, or an offset to that for non-SN mobile device, (3) a number of beams which can be used for selection of the highest ranked cell, or the number of beams used for derivation of cell measurement quantity, for current serving frequency or inter-frequency, (4) a cell reselection timer value, which may be configured for a specific frequency, or alternatively or additionally, an offset to the cell reselection timer value for non-SN device, or alternatively or additionally, an scaling factor to cell reselection timer value for non-SN device, (5) the RSRP or RSRQ threshold(s) used by the SN MT when re-selecting towards a higher/lower/equal priority frequency than the current serving frequency, or alternatively or additionally, an offset to the RSRP or RSRQ threshold used by the SN MT when re-selecting towards a higher/lower/equal priority frequency than the current serving frequency for non-SN device, (6) an RSRP or RSRQ threshold for intra-frequency or inter-frequency measurements, or alternatively or additionally, an offset to the RSRP or RSRQ threshold for intra-frequency or inter-frequency measurements for non-SN mobile device, (7) a minimum required transceiver (Rx) level or RSRQ in the cell, or alternatively or additionally, an offset to the minimum required Rx level or RSRQ in the cell for non-SN mobile device, (8) an offset between the two cells, or alternatively or additionally, an offset to the offset between two cells for non-SN mobile device, (9) a frequency specific offset for equal priority NR frequencies, or alternatively or additionally, an offset to the frequency specific offset for equal priority NR frequencies for non-SN mobile device, (10) a hysteresis value for ranking criteria, or alternatively or additionally, a scaling factor for hysteresis value, or alternatively or additionally, an offset to the hysteresis value for ranking criteria for non-SN mobile device, (11) an RSRP or RSRQ threshold for relaxed measurement, or alternatively or additionally, an offset to the RSRP or RSRQ threshold for relaxed measurement for non-SN mobile device, (12) a RSRP or RSRQ threshold to evaluate not-at-cell-edge-criterion for relaxed measurement, or alternatively or additionally, an offset to the RSRP or RSRQ threshold evaluate not-at-cell-edge-criterion for relaxed measurement for non-SN mobile device, or (13) a threshold on a RSRP variation to evaluate stationary criterion for relaxed measurement, or alternatively or additionally, an offset to the threshold on RSRP variation to evaluate stationary criterion for relaxed measurement for non-SN mobile device.

Here, the BS can provide a separate cell selection or re-selection configuration for an SN MT. Considering the different characteristics and functions from normal mobile devices, it is beneficial to keep an SN MT in the last serving cell before it is released to the RRC_IDLE or RRC_INACTIVE state. To achieve this, the BS can configure more strict condition(s) for cell re-selection (e.g. a higher hysteresis value for ranking criteria or a higher cell reselection timer value). Thus, the SN MT is not likely to re-select a new serving cell due to short term variation of radio environment.

The BS can configure different frequency priorities or a different frequency list for cell reselection for an SN MT from that for a regular UE. It is beneficial to do so because of the difference between the function of an SN and a regular UE. Then, the BS can implement different policies in frequency selection during a cell re-selection procedure between the SN MT and a regular mobile termination.

When a BS releases the SN MT to the RRC_IDLE or RRC_INACTIVE state, it may configure a forwarding configuration to the SN MT. The SN FWD may, thereby, perform forwarding according to the forwarding configuration. The forwarding configuration may be associated with a specific cell's configuration. For example, the forwarding configuration may include the rule on how to forward the periodic common channels configured for the cell. The configuration of common channel may be different among cells.

However, when a mobile device is released to the RRC_IDLE or RRC_INACTIVE state, it may perform cell selection procedure, meaning that the new serving cell after cell selection procedure may not be the last serving cell in which the SN MT is released. As a consequence, the forwarding configuration that is associated with a specific cell, e.g. the last serving cell before the SN MT is released to RRC_IDLE or RRC_INACTIVE, may not be applicable in the newly re-selected serving cell.

According to some embodiments of this disclosure, the BS may configure information of one or more candidate or preferred cells for the SN MT, such that the SN MT can select the identified or defined one or more candidate or preferred cells in the reselection or selection procedure.

For example, the one or more candidate or preferred cells may be the last serving cell of the SN MT before it is transited to the RRC_IDLE or RRC_INACTIVE state. In this case, the BS may indicate the cell by including an indicator in the RRC message or system information. The indicator may be used to indicate that the cell selection should not be performed upon the reception of the RRC release message. Alternatively or additionally, the indicator may be used to indicate the SN MT to select or re-select the current serving cell.

According to an example, the one or more candidate or preferred cells may be indicated by a cell identifier of the one or more candidate cells. The BS may configure the one or more candidate cells. In this case, the SN MT may perform cell selection or re-selection among the one or more candidate or preferred cells as indicated by the cell identifiers. For example, the one or more candidate or preferred cells may be the redirected cell which is configured by the BS when SN MT is released to the RRC_IDLE or RRC_INACTIVE state.

According to an example, the one or more candidate or preferred cells may be indicated by a carrier information. In this case, the SN MT may treat all cells on the said carrier as applicable cells. The SN MT may perform cell selection or re-selection according to the carrier information. The SN MT may perform cell selection or re-selection among these cells. The carrier may be the redirect carrier, which can be configured by BS when the SN MT is released to the RRC_IDLE or RRC_INACTIVE state.

According to an example, the one or more candidate or preferred cells may be the cells associated with a forwarding configuration. The BS may configure the forwarding configuration with information of associated cells included.

In the examples above, the BS may perform forwarding if its serving cell is one of the one or more candidate or preferred cells. The BS may stop applying the forwarding configuration if its serving cell is not one of the identify candidate or preferred cells. Alternatively or additionally, the SN MT may treat the one or more candidate or preferred cells with a highest priority for cell selection or re-selection. The SN MT may preferably select or re-select one of the one or more candidate or preferred cells as serving cell.

In case the BS configures only one candidate cell, the SN MT may select or re-select the only one candidate cell as serving cell. The cell selection or reselection may be performed when the SN MT is released to the RRC_IDLE or RRC_INACTIVE state or when the SN MT is in the RRC_IDLE or RRC_INACTIVE state.

Thereby, the BS can control the cell the SN would camp on when the SN MT is in the RRC_IDLE or RRC_INACTIVE state. It can avoid the SN MT camping on a cell for which a forwarding configuration is not applicable, and forwarding cannot be performed.

According to some embodiments of this disclosure, the BS may indicate the applicability of forwarding configuration based on the cell of the SN. For example, the BS may configure one or more sets of forwarding configurations. Each forwarding configuration may be associated with at least one specific cell (or applicable cell) or at least one specific frequency (or applicable frequency). The forwarding configurations may be configured by the BS to the SN MT via an RRC message. The associated cells or frequencies to the corresponding forwarding configurations may be configured by the BS to the SN MT via an RRC message or system information.

Therefore when an SN MT is in the RRC_IDLE or RRC_INACTIVE state, a forwarding configuration may be applied by the SN MT or an SN FWD part when the SN MT is camping on an applicable cell or an applicable frequency associated with or applicable to the forwarding configuration.

When an SN MT is in the RRC_IDLE or RRC_INACTIVE state, a forwarding configuration may not be applied and may be disregarded by the SN MT or an SN FWD part when the SN MT does not camp on an applicable cell or an applicable frequency applicable to or associated with the forwarding configuration.

In this disclosure, a forwarding configuration can be associated with a cell, meaning that the forwarding configuration can be applied to an SN FWD when the cell is SN MT's serving cell. In this disclosure, a forwarding configuration can be applicable in a cell, meaning that the forwarding configuration is applicable when the cell is the SN MT's serving cell.

One or more embodiments of this disclosure provides a wireless communication method, including: receiving, by a wireless communication node, a forwarding configuration from a base station (BS), the forwarding configuration being associated with at least one first cell or at least one first frequency; and applying the forwarding configuration if a MT (mobile termination) part of the wireless communication node camps on the at least one first cell or at least one first frequency.

Optionally for one or more wireless communication methods of this disclosure, it further includes comprising applying another forwarding configuration rather than the forwarding configuration when the MT part of the wireless communication node does not camp on the at least one first cell or at least one first frequency.

Optionally for one or more wireless communication methods of this disclosure, it further includes receiving, from the BS, a cell selection or reselection configuration, which indicates whether cell reselection is allowed when the MT part of the wireless communication node is in an RRC idle state or an RRC inactive state.

Optionally for one or more wireless communication methods of this disclosure, it further includes performing cell re-selection according to a cell selection or reselection configuration received from the BS when the MT part of the wireless communication node is in an RRC idle state or an RRC inactive state.

Optionally for one or more wireless communication methods of this disclosure, the cell selection or reselection configuration indicates candidate cell(s) or preferred cell(s) to be selected or reselected by the MT part.

Optionally for one or more wireless communication methods of this disclosure, the candidate cell(s) or preferred cell(s) includes a last serving cell of the MT part before the MT part transited to the RRC idle state or RRC inactive state.

Optionally for one or more wireless communication methods of this disclosure, the cell selection or reselection configuration indicates the candidate cell(s) or preferred cell(s) by one or more identifiers of the candidate cell(s) or preferred cell(s) or by carrier information of the candidate cell(s) or preferred cell(s).

Optionally for one or more wireless communication methods of this disclosure, the cell selection or reselection configuration indicates priorities of the candidate cell(s) or preferred cell(s) to be selected or reselected.

Optionally for one or more wireless communication methods of this disclosure, the forwarding configuration further indicates a cell selection or reselection configuration associated to the forwarding configuration.

Optionally for one or more wireless communication methods of this disclosure, the wireless communication method further includes receiving a cell selection or reselection configuration from the BS, wherein the cell selection or reselection configuration is different from that for user equipment (UE) connected with the BS via the wireless communication node.

One or more embodiments of this disclosure provides a wireless communication method, including: establishing a backhaul link between a base station (BS) and a wireless communication node; and sending, by the BS to the wireless communication node, a forwarding configuration to be applied by the wireless communication node when a MT (mobile termination) part of the wireless communication node camps on at least one first cell or at least one first frequency associated with the forwarding configuration.

Optionally for one or more wireless communication methods of this disclosure, it further includes providing another forwarding configuration rather than the forwarding configuration when the MT part of the wireless communication node does not camp on the at least one first cell or at least one first frequency.

Optionally for one or more wireless communication methods of this disclosure, it further includes sending, by the BS, a cell selection or reselection configuration, which indicates whether cell reselection is allowed when the MT part of the wireless communication node is in an RRC idle state or an RRC inactive state.

Optionally for one or more wireless communication methods of this disclosure, it further includes comprising providing a cell selection or reselection configuration to configure cell re-selection of the MT part of the wireless communication node in an RRC idle state or an RRC inactive state.

Optionally for one or more wireless communication methods of this disclosure, the cell selection or reselection configuration indicates candidate cell(s) or preferred cell(s) to be selected or reselected.

Optionally for one or more wireless communication methods of this disclosure, the candidate cell(s) or preferred cell(s) includes a last serving cell of the MT part before the MT part transited to the RRC idle state or the RRC inactive state.

Optionally for one or more wireless communication methods of this disclosure, the cell selection or reselection configuration indicates the candidate cell(s) or preferred cell(s) by one or more identifiers of the candidate cell(s) or preferred cell(s) or by carrier information of the candidate cell(s) or preferred cell(s).

Optionally for one or more wireless communication methods of this disclosure, the cell selection or reselection configuration indicates priorities of candidate cell(s) or preferred cell(s) to be selected or reselected.

Optionally for one or more wireless communication methods of this disclosure, the forwarding configuration further indicates a cell selection or reselection configuration associated to the forwarding configuration.

Optionally for one or more wireless communication methods of this disclosure, it further includes sending a cell selection or reselection configuration by the BS, wherein the cell selection or reselection configuration is different from that for user equipment (UE) connected with the BS via the wireless communication node.

One or more embodiments of this disclosure provides a wireless communication method, including: establishing a backhaul link between a base station (BS) and a wireless communication node; and controlling a forwarding operation of a forwarding part of the wireless communication node according to at least one of following factors, including a reference signal measurement result, a radio link quality of the backhaul link, a timer which starts in response to a MT (mobile termination) part of the wireless communication node enters an RRC idle state or an RRC inactive state, or a selection or reelection of a serving cell of the MT part.

Optionally for one or more wireless communication methods of this disclosure, controlling the forwarding operation comprises performing at least one of the following actions, including stopping forwarding packets or radio signals from a user equipment (UE) to the BS or disregarding an forwarding configuration by the MT part or the forwarding part.

Optionally for one or more wireless communication methods of this disclosure, controlling the forwarding operation according to at least one of the factors comprises performing the at least one of the actions when at least one of the following conditions is met, the conditions including: the reference signal measurement result meet a measurement result condition, occurrence of a beam failure of a reference signal, a determination that a reference signal associated with the backhaul link quality is not a reference signal of a best radio quality for a period, a radio link quality of the backhaul link inferior than a threshold status, a value of the timer reaches a threshold time, the MT part selecting or reselecting a serving cell rather than the last serving cell before the MT part transited to the RRC idle state or the RRC inactive state, the MT part selecting or reselecting a serving cell out of a pre-defined frequency range, the MT part selecting or reselecting a serving cell rather than a suitable cell, the MT part selecting or reselecting a serving cell rather than a cell with a predefined priority range, or the MT part selecting or reselecting a serving cell rather than a configured candidate cell.

Optionally for one or more wireless communication methods of this disclosure, it further includes starting a procedure to setup or resume an RRC connection between the wireless communication node and the BS.

One or more embodiments of this disclosure provides a wireless communication method, including: establishing a backhaul link between a base station and a wireless communication node; and receiving forwarded packets or radio signals from a forwarding part of the wireless communicant node via a forwarding operation controlled according to at least one of following factors, including a reference signal measurement result, a radio link quality of the backhaul link, a timer which starts in response to a MT (mobile termination) part of the wireless communication node enter an RRC idle state or an RRC inactive state, a selection or reelection of a serving cell of the MT part.

Optionally for one or more wireless communication methods of this disclosure, it further includes ceasing receiving forwarded packets or radio signals from a user equipment (UE) to the BS.

Optionally for one or more wireless communication methods of this disclosure, it further includes ceasing receiving forwarded packets or radio signals when at least one of the following conditions is met, the conditions including: the reference signal measurement result meet a measurement result condition, occurrence of a beam failure of a reference signal, a determination that a reference signal associated with the backhaul link quality is not a reference signal of a best connection quality for a period, a radio link quality of the backhaul link inferior than a threshold status, a value of the timer reaches a threshold time, the MT part selecting or reselecting a serving cell rather than the last serving cell before the MT part transited to the RRC idle state or the RRC inactive state, the MT part selecting or reselecting a serving cell out of a pre-defined frequency range, the MT part selecting or reselecting a serving cell rather than a suitable cell, the MT part selecting or reselecting a serving cell rather than a cell with a predefined priority range, or the MT part selecting or reselecting a serving cell rather than a configured candidate cell.

Optionally for one or more wireless communication methods of this disclosure, it further includes responding to a procedure to setup or resume an RRC connection between the wireless communication node and the BS.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1-24. (canceled)

25. A wireless communication method, comprising:
establishing, by a wireless communication node, a backhaul link between a base station and the wireless communication node; and
ceasing, by the wireless communication node, forwarding radio signals to the base station according to at least one of following factors: a reference signal measurement result, a radio link quality of the backhaul link, a condition that a mobile termination (MT) part of the wireless communication node enters an RRC idle state or an RRC inactive state, and a selection or reelection of a serving cell by the MT part.

26. (canceled)

27. The method of claim 25, further comprising:
determining, by the wireless communication node, whether to cease forwarding the radio signals to the base station when at least one of the following conditions is met, the conditions including: occurrence of a beam failure of a reference signal for the MT part, the MT part selecting or reselecting a serving cell other than the last serving cell before the MT part transited to the RRC inactive state, and the MT part selecting or reselecting a serving cell other than a suitable cell.

28. (canceled)

29. (canceled)

30. (canceled)

31. The method of claim 25, wherein the ceasing forwarding the radio signals to the base station comprises:
in response to the MT part in the RRC inactive state selecting or reselecting a serving cell other than the last serving cell, ceasing, by the wireless communication node, forwarding the radio signals to the base station.

32. The method of claim 25, wherein the ceasing forwarding the radio signals to the base station comprises:
in response to the MT part in the RRC inactive state selecting or reselecting a serving cell that is not a suitable cell, ceasing, by the wireless communication node, forwarding the radio signals to the base station.

33. An apparatus comprising:
a memory storing instructions; and
at least one processor in communication with the memory, wherein, when the at least one processor executes the instructions, the at least one processor is configured to cause the apparatus to perform:
establishing a backhaul link between a base station and the apparatus; and
ceasing forwarding radio signals to the base station according to at least one of following factors: a reference signal measurement result, a radio link quality of the backhaul link, a condition that a MT (mobile termination) part of the apparatus enters an RRC idle state or an RRC inactive state, and a selection or reelection of a serving cell by the MT part.

34. The apparatus according to claim 33, wherein, when the at least one processor executes the instructions, the at least one processor is configured to further cause the apparatus to perform:
determining whether to cease forwarding the radio signals to the base station when at least one of the following conditions is met, the conditions including: occurrence of a beam failure of a reference signal for the MT part, the MT part selecting or reselecting a serving cell other than the last serving cell before the MT part transited to the RRC inactive state, and the MT part selecting or reselecting a serving cell other than a suitable cell.

35. The apparatus according to claim 33, wherein, when the at least one processor is configured to cause the apparatus to perform ceasing forwarding the radio signals to the base station, the at least one processor is configured to cause the apparatus to perform:
in response to the MT part in the RRC inactive state selecting or reselecting a serving cell other than the last serving cell, ceasing forwarding the radio signals to the base station.

36. The apparatus according to claim 33, wherein, when the at least one processor is configured to cause the apparatus to perform ceasing forwarding the radio signals to the base station, the at least one processor is configured to cause the apparatus to perform:
in response to the MT part in the RRC inactive state selecting or reselecting a serving cell that is not a suitable cell, ceasing forwarding the radio signals to the base station.

37. A non-transitory computer-readable medium storing instructions, wherein, the instructions, when executed by at least one processor in a wireless communication node, are configured to cause the wireless communication node to perform:
establishing a backhaul link between a base station and the wireless communication node; and
ceasing forwarding radio signals to the base station according to at least one of following factors: a reference signal measurement result, a radio link quality of the backhaul link, a condition that a MT (mobile termination) part of the wireless communication node enters an RRC idle state or an RRC inactive state, and a selection or reelection of a serving cell by the MT part.

38. The non-transitory computer-readable medium according to claim 37, wherein, the instructions, when executed by the at least one processor, are configured to further cause the wireless communication node to perform:
determining whether to cease forwarding the radio signals to the base station when at least one of the following conditions is met, the conditions including: occurrence of a beam failure of a reference signal for the MT part, the MT part selecting or reselecting a serving cell other than the last serving cell before the MT part transited to the RRC inactive state, and the MT part selecting or reselecting a serving cell rather other a suitable cell.

39. The non-transitory computer-readable medium according to claim 37, wherein, when the instructions are configured to further cause the wireless communication node to perform ceasing forwarding the radio signals to the base station, the instructions are configured to cause the wireless communication node to perform:
in response to the MT part in the RRC inactive state selecting or reselecting a serving cell other than the last serving cell, ceasing forwarding the radio signals to the base station.

40. The non-transitory computer-readable medium according to claim 37, wherein, when the instructions are configured to further cause the wireless communication node to perform ceasing forwarding the radio signals to the base station, the instructions are configured to cause the wireless communication node to perform:
in response to the MT part in the RRC inactive state selecting or reselecting a serving cell that is not a suitable cell, ceasing, by the wireless communication node, forwarding the radio signals to the base station.
